(19) United States
(12) Patent Application Publication
(10) Pub. No.: US 2024/0282293 A1
(43) Pub. Date: Aug. 22, 2024

(54) LEARNING SYSTEM, LEARNING METHOD, AND LEARNING PROGRAM

(71) Applicant: NIPPON TELEGRAPH AND TELEPHONE CORPORATION, Tokyo (JP)

(72) Inventors: Hidetaka KOYA, Tokyo (JP); Akira KATAOKA, Tokyo (JP); Makoto KOMIYAMA, Tokyo (JP)

(73) Assignee: NIPPON TELEGRAPH AND TELEPHONE CORPORATION, Tokyo (JP)

(21) Appl. No.: 18/567,746

(22) PCT Filed: Jun. 10, 2021
(86) PCT No.: PCT/JP2021/022223

§ 371 Date: Dec. 6, 2023

(51) Int. Cl. G10L 15/06; G10L 15/22

(52) U.S. Cl. CPC G10L 15/063; G10L 15/22

(57) ABSTRACT

A learning system includes an obtainer and a learner. The obtainer obtains information observed around a user who has uttered a voice command. The learner learns the information obtained by the obtainer as a condition for executing the voice command.

### TECHNICAL FIELD

The present disclosure relates to a learning system, a learning method, and a learning program.

### BACKGROUND ART

In recent years, various techniques have been suggested to operate various devices and information systems by voice commands. Examples of suggested techniques include an extended voice command method (Non Patent Literature 1 mentioned below) for enabling acceptance of not only fixed phrases but also unrestricted utterances of users, and a voice command system (Non Patent Literature 2 mentioned below) that allows users to define and set voice commands, to generate flexible voice commands.

In generating such a flexible voice command, it is important to correctly define an execution condition for each voice command. For example, by the technique according to Non Patent Literature 2 mentioned below, a user utters “check the input” or “input the ledger sheet” in a situation where a system screen is open. In this case, by the technique according to Non Patent Literature 2, a check can be made to determine whether the input to the system screen is correct. Further, by this technique, the user can define a voice command for transcribing information written on a printed ledger sheet by voice. The user can use the voice command the user has defined.

However, there are cases where a plurality of business systems are being used in operation, and there also are cases where each business system has a different ledger input screen. In such cases, the common phrases “check the input” and “input the ledger sheet” mentioned above cannot be defined as voice commands as they are.

For example, it is necessary to define a voice command by dividing a common phrase “input the ledger sheet” into phrases such as “input the ledger sheet to the system A” and “input the ledger sheet to the system B”. However, if the user utters “input the ledger sheet” while the system A is open to the user, it is obvious that the user wishes to execute the voice command on the system A.

From such a background, it is conceivable that the user may give an execution condition to a voice command, to generate a flexible voice command. Execution conditions for voice commands can prevent generation of an excessive number of voice commands. In the above example, an execution condition is “when the system A is open”, for example.

Giving an execution condition to a voice command is expected to prevent execution of the voice command in a dangerous situation. Also, defining a voice recognition corpus for each execution condition is expected to increase the accuracy of voice recognition.

### CITATION LIST

### Non Patent Literature

Non Patent Literature 1: Kurata, Ichikawa, and Nishimura, “Speech Input Method in Automobiles Reflecting Analysis on How Users Speak”, IEICE Transactions D, Information and systems, 93 (10), 2107-2117, 2010-10-01
Non Patent Literature 2: Koya, Komiyama, Kataoka, and Oishi, “Proposal and Usability Testing of the Voice Command System for End-User”, IEICE Technical Report, vol. 120, no. 323, ICM2020-41, pp. 39-44, January 2021

### SUMMARY OF INVENTION

### Technical Problem

By the above conventional techniques, however, it might be difficult to put a restriction on a voice command, depending on a situation of the user.

For example, imposing a restriction on a voice command with an execution condition might require (1) defining an execution condition for the voice command on the basis of information observed around the speaker, (2) giving the execution condition to the voice command in advance, and (3) determining whether the current situation of the speaker matches the execution condition.

However, there are cases where it is difficult to define an execution condition inclusive of various situations. For example, there are cases where the user needs to understand information indicated by each situation, and create a definition of an execution condition.

In particular, in a case where one voice command is executable in multiple situations, the corresponding skills are required to correctly define an execution condition that matches those multiple situations. Further, in a case where the user wishes to change an execution condition, the user needs to newly create a definition and define the execution condition. Therefore, the operation required for the correction is also large.

Therefore, the present disclosure suggests a learning system, a learning method, and a learning program capable of easily putting a restriction on a voice command, depending on a situation of a user.

### Solution to Problem

In a mode of the present disclosure, a learning system includes: an obtainer that obtains information observed around a user who has uttered a voice command; and a learner that learns the information obtained by the obtainer as a condition for executing the voice command.

### Advantageous Effects of Invention

A learning system according to one or more embodiments of the present disclosure can easily restrict a voice command, depending on a situation of a user.

### BRIEF DESCRIPTION OF DRAWINGS

FIG. 1 illustrates an example problem related to a restriction on a voice command.

FIG. 2 is a block diagram of an example environment for learning an execution condition for a voice command.

FIG. 3 illustrates an outline of an execution condition learning process according to the present disclosure.

FIG. 4 is a block diagram of an example configuration of an execution condition learning system according to the present disclosure.

FIG. 5 illustrates an example of a peripheral information obtaining process according to the present disclosure.

FIG. 6A illustrates an example of an execution condition determining process according to the present disclosure.

FIG. 6B illustrates an example of an execution condition determining process according to the present disclosure.

FIG. 7 illustrates an example of an execution condition learning process according to the present disclosure.

FIG. 8 is a flowchart showing an example process for learning an execution condition for a voice command.

FIG. 9 illustrates an example hardware configuration of a computer.

### DESCRIPTION OF EMBODIMENTS

The following is a detailed description of embodiments, with reference to the drawings. Note that the present invention is not limited to these embodiments. A plurality of various features of the embodiments may be combined in various manners, provided that the features do not contradict each other. The same components are denoted by the same reference numerals, and explanation thereof will not be repeated.

### 1. INTRODUCTION

There are cases where a speaker who uses voice commands wishes to put a restriction on an executable voice command in accordance with a situation of the speaker, to reduce erroneous recognition and prevent an increase in the number of commands, from the viewpoint of security.

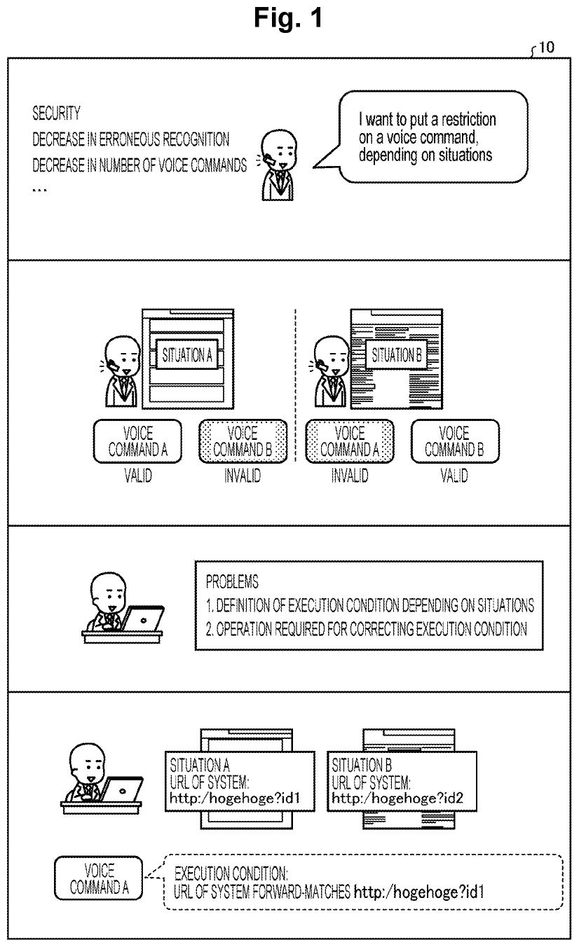

FIG. 1 illustrates a problem 10 that is an example of a problem related to a restriction on a voice command. In the problem 10, the speaker is a user who uses a system that can execute voice commands. In the example illustrated in FIG. 1, the user wishes to put a restriction on a voice command B in a situation A. For example, the user disables the voice command B in the situation A. In this case, even if the user utters the voice command B in the situation A, the voice command B is not executed.

However, to restrict a voice command, the creator of the voice command needs to give an execution condition in advance, for example. In this case, the following two problems are conceivable.

The first problem is that it is difficult for the creator (the user, for example) of the voice command to consider execution conditions in various situations, and define an execution condition. The second problem is that, in a case where the creator of the voice command wishes to correct the execution condition, the correction of the execution condition requires an operation. As illustrated in FIG. 1, the creator needs to correct an execution condition registered in a voice command system that operates a business system with voice commands, for example. The creator registers the uniform resource locator (URL) of the system as an execution condition of a voice command, for example. An example of the execution condition is “the URL of the system forward-matches http:/hogehoge”.

To solve the above problem, an execution condition learning system according to one or more embodiments of the present disclosure performs one or more execution condition learning processes described below.

### 2. ENVIRONMENT FOR EXECUTION CONDITION LEARNING

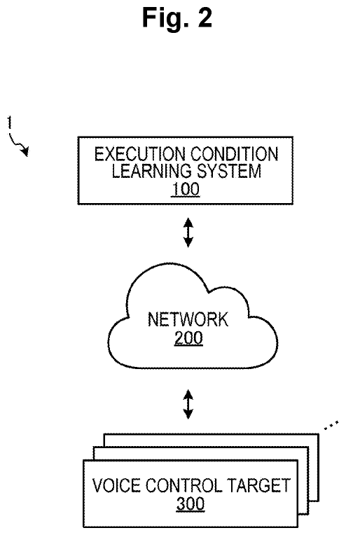

First, an environment for execution condition learning according to the present disclosure is described with reference to FIG. 2.

FIG. 2 is a block diagram of an environment 1 that is an example of an environment for learning an execution condition for a voice command. As illustrated in FIG. 2, the environment 1 includes an execution condition learning system 100, a network 200, and a voice control target 300.

The execution condition learning system 100 is a system that performs one or more execution condition learning processes. The execution condition learning system 100 interactively learns an execution condition for a voice command. The one or more execution condition learning processes include a process of learning an execution condition for a voice command. An outline of an execution condition learning process according to the present disclosure will be described in the next chapter.

The execution condition learning system 100 includes one or more data processing devices. A data processing device is a server, for example. An example configuration of the execution condition learning system 100 will be described in chapter 4.

The network 200 is a network such as the Internet, a local area network (LAN), a wide area network (WAN), or the like, for example. The network 200 connects the execution condition learning system 100 and the voice control target 300.

The voice control target 300 is the target of voice control. The voice control target 300 is a user interface (UI) in a business system, one of various devices (such as home electric appliances), or the like, for example. In a case where the business system includes the voice control target 300, the voice control target 300 is a graphical user interface (GUI), for example. In this case, the GUI is automatically operated, to implement a voice command.

For example, in a case where the execution condition learning system 100 receives a voice command, the execution condition learning system 100 can operate the GUI using an accessibility application programming interface (API).

### 3. OUTLINE OF AN EXECUTION CONDITION LEARNING PROCESS

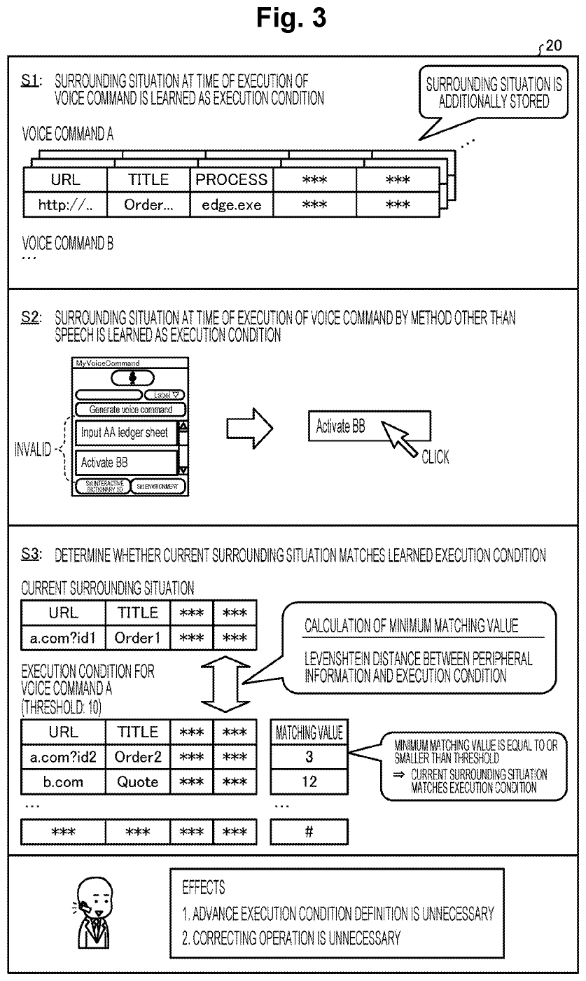

Next, an outline of an execution condition learning process according to the present disclosure is described with reference to FIG. 3. Note that this outline is not intended to limit the present invention and the embodiments to be described in the later chapters.

FIG. 3 illustrates an outline 20 of an execution condition learning process according to the present disclosure.

In the outline 20, the execution condition learning system 100 first learns the surrounding situation at the time of execution of a voice command as an execution condition for the voice command (step S1). The surrounding situation is a situation surrounding the user. For example, in a case where the user is using a certain system (a business system, for example), the surrounding situation is a situation such as the URL of the system screen, the title, and the process name.

The execution condition learning system 100 also learns the surrounding situation at the time of execution of the voice command by a method other than speech, as an execution condition (step S2). The execution condition learning system 100 has a UI for executing a voice command by a method other than speech.

In a case where the surrounding situation at the time of execution of the voice command does not match the currently learned execution condition, the voice command is not executed by speech. In this case, the user can execute the voice command by a method other than speech. For example, the user can click a particular voice command from a list of voice commands.

In the example illustrated in FIG. 2, the execution condition learning system 100 cannot execute an invalid voice command, such as ledger inputting, by speech. However, the execution condition learning system 100 can execute an invalid voice command by a method other than speech, such as a list of voice commands. The execution condition learning system 100 can learn the surrounding situation at the time of execution of the invalid voice command. The execution condition learning system 100 may learn the surrounding situation, using information indicating how many times a certain voice command has been clicked, for example.

In a case where the user has uttered a voice command, the execution condition learning system 100 determines whether the current surrounding situation matches the learned execution condition (step S3). The execution condition learning system 100 can determine matching of an execution condition, on the basis of a matching value and a threshold.

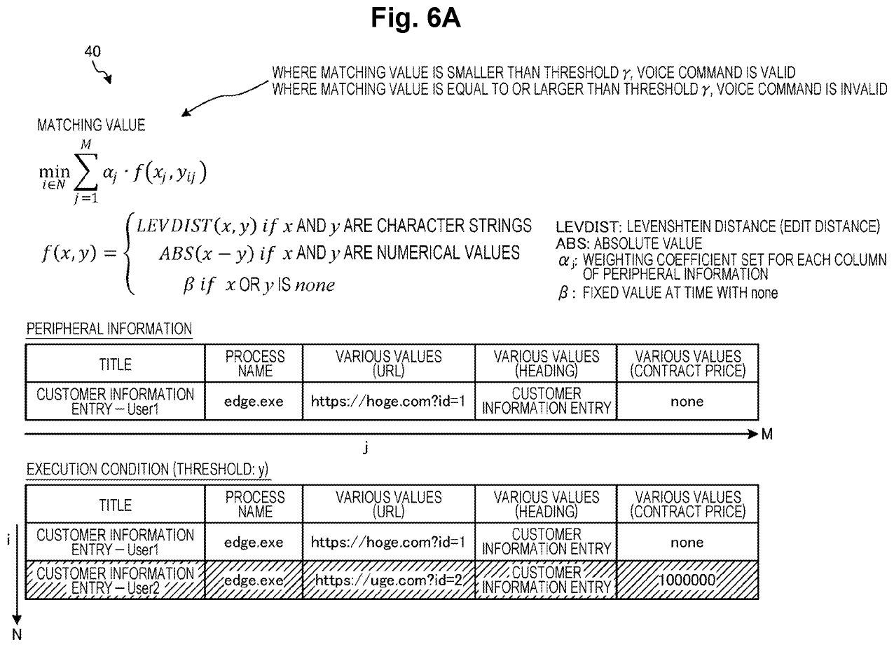

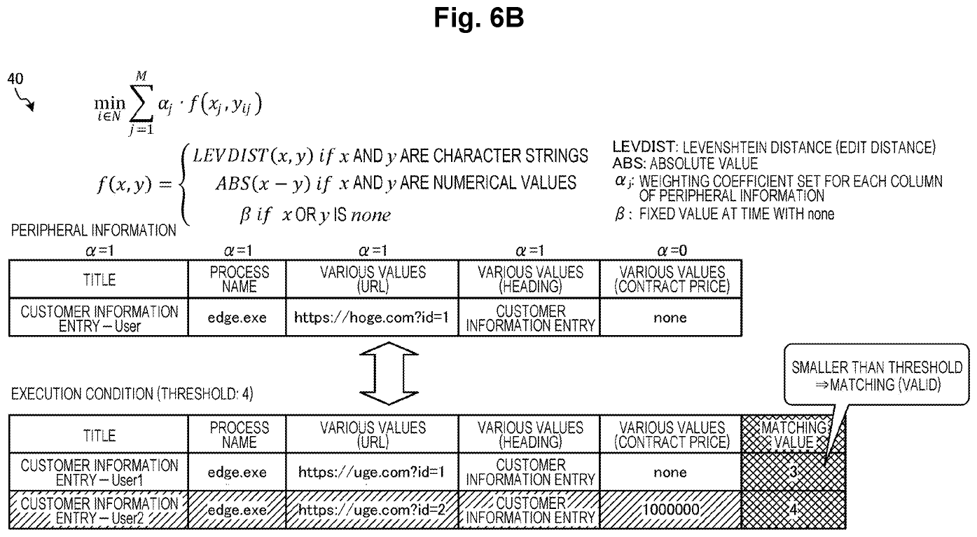

For example, an example of the matching value is the Levenshtein distance between peripheral information and an execution condition. The Levenshtein distance will be described later with reference to FIGS. 6A and 6B. In a case where the matching value is the Levenshtein distance, the smaller the matching value, the more the peripheral information matches the execution condition.

The execution condition learning system 100 calculates the minimum matching value. In the example illustrated in FIG. 3, the minimum matching value is 3. In this example, the threshold is 10. As the current surrounding situation meets at least one execution condition, the execution condition learning system 100 executes a voice command A.

As described above, the execution condition learning system 100 learns an execution condition through interactive teaching. Thus, the execution condition learning system 100 can eliminate the need to define execution conditions in advance. The execution condition learning system 100 can make correcting operations unnecessary.

### 4. CONFIGURATION OF THE EXECUTION CONDITION LEARNING SYSTEM

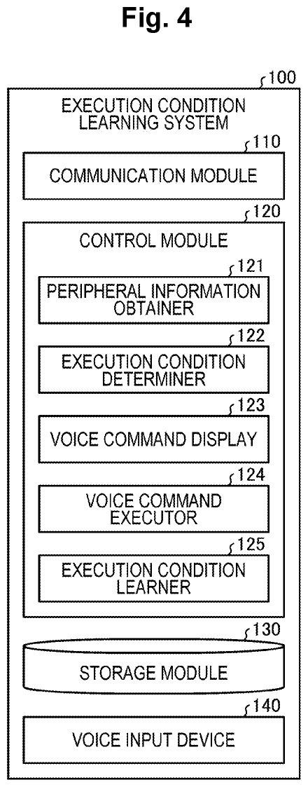

Next, an example configuration of the execution condition learning system 100 is described with reference to FIG. 4.

FIG. 4 is a block diagram of the execution condition learning system 100, which is an example configuration of an execution condition learning system according to the present disclosure. The execution condition learning system 100 is an example of the learning system.

As illustrated in FIG. 4, the execution condition learning system 100 includes a communication module 110, a control module 120, a storage module 130, and a voice input device 140. The execution condition learning system 100 may include an input module (a keyboard and a mouse, for example) that receives an input from an administrator of the execution condition learning system 100. The execution condition learning system 100 may also include an output module (a liquid crystal display or an organic electro-luminescence (EL) display, for example) that displays information to the administrator of the execution condition learning system 100.

### [4-1. Communication Module 110]

The communication module 110 is implemented with a network interface card (NIC), for example. The communication module 110 is connected to the network 200 in a wired or wireless manner. The communication module 110 can transmit and receive information to and from the voice control target 300 via the network 200.

### [4-2. Control Module 120]

The control module 120 is a controller. The control module 120 is implemented by one or more processors (a central processing unit (CPU) or a micro processing unit (MPU), for example) that use a random access memory (RAM) as a work area and execute various kinds of programs stored in a storage device in the execution condition learning system 100. Alternatively, the control module 120 may be implemented by an integrated circuit such as an application specific integrated circuit (ASIC), a field programmable gate array (FPGA), a general purpose graphic processing unit (GPGPU), or the like.

As illustrated in FIG. 4, the control module 120 includes a peripheral information obtainer 121, an execution condition determiner 122, a voice command display 123, a voice command executor 124, and an execution condition learner 125. One or more processors in the execution condition learning system 100 can implement each control module by executing an instruction stored in one or more memories in the execution condition learning system 100. The data processing to be performed by each control module is an example, and each control module (the execution condition learner 125, for example) may perform data processing described below in association with another control unit (the voice command executor 124, for example).

The execution condition learner 125 of the execution condition learning system 100 learns the surrounding situation at the time of execution of a voice command, to eliminate the need to define the execution condition of the voice command in advance and to correct the execution condition. For the voice command, the execution condition learning system 100 includes the voice command display 123 as an execution method other speech (clicking or tapping the corresponding command from a list of voice commands). The execution condition determiner 122 of the execution condition learning system 100 can determine matching of an execution condition, on the basis of a matching value and a threshold.

### [4-2-1. Peripheral Information Obtainer 121]

The peripheral information obtainer 121 obtains peripheral information about the speaker. The peripheral information obtainer 121 is an example of the obtainer.

The peripheral information is information observed around the user who has uttered the voice command. The peripheral information includes various kinds of information (the surrounding environment and the surrounding situation) regarding the surroundings of the user who has made the utterance. The various kinds of information regarding the surroundings of the user are information regarding the system being used by the user, for example. The peripheral information regarding the system includes at least one of the title of the foremost system screen, the process name (a numerical value), and a value displayed on the system screen (a character string or a numerical value).

The peripheral information obtainer 121 can acquire peripheral information from various kinds of systems (a business system, for example). The peripheral information obtainer 121 can store the peripheral information into the storage module 130. The peripheral information obtainer 121 can also obtain peripheral information from the storage module 130.

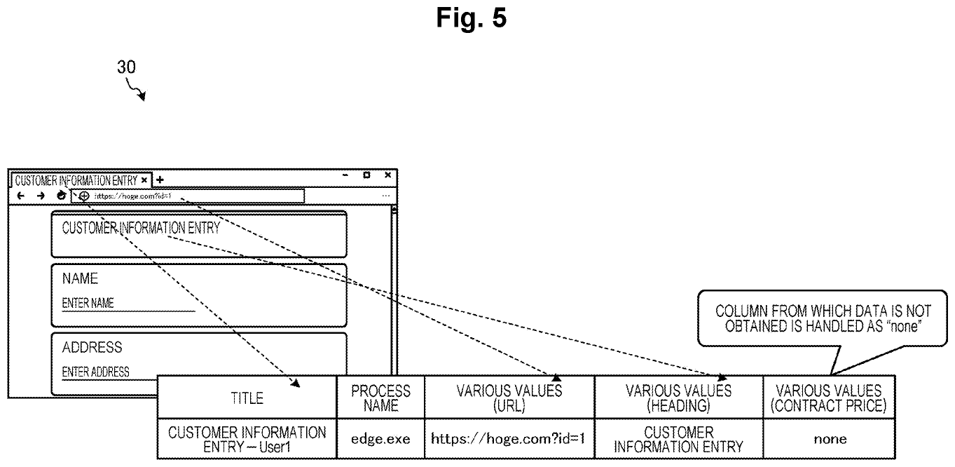

FIG. 5 illustrates a peripheral information obtaining process 30 that is an example of a peripheral information obtaining process according to the present disclosure. In the peripheral information obtaining process 30, the peripheral information obtainer 121 obtains information regarding a voice command input screen that can accept a voice command from the user. The voice command input screen is the system screen, for example.

The peripheral information obtained by the peripheral information obtainer 121 is used as an execution condition for the voice command. In the example illustrated in FIG. 5, the peripheral information is data including a plurality of character strings or numerical values. In a case where the target voice command system operates a GUI of the system by voice, the obtained peripheral information includes at least one of the data mentioned below. The data included in the peripheral information is the title (a character string) of the foremost system screen, the process name (a numerical value) of the foremost system screen, various values (character strings and numerical values) displayed on the foremost system screen, and the like. Columns for which no data can be obtained are treated as “none”.

The peripheral information is not necessarily data information related to the system screen. The peripheral information may be information observed by a peripheral device of the user. For example, in a case where the peripheral device is a wearable device, the peripheral information may be sensing data (a heart rate or an eyeball potential, for example).

### [4-2-2. Execution Condition Determiner 122]

The execution condition determiner 122 identifies the condition for executing a voice command. The execution condition determiner 122 then determines whether the information acquired by the peripheral information obtainer 121 matches the identified condition. The execution condition determiner 122 is an example of the determiner.

The condition for executing the voice command is the execution condition for the voice command, and the execution condition determiner 122 can identify the execution condition by referring to a plurality of execution conditions stored in the storage module 130.

FIGS. 6A and 6B collectively illustrate an execution condition determining process 40 that is an example of an execution condition determining process according to the present disclosure. In the execution condition determining process 40, the execution condition determiner 122 determines validity/invalidity of the voice command, using the peripheral information and the execution condition for the voice command as inputs. The execution condition determiner 122 further determines the execution condition, on the basis of a matching value and a threshold. The matching value is a value indicating how much the peripheral information obtained by the peripheral information obtainer 121 differs from the identified condition.

The execution condition determiner 122 uses the current peripheral information at the time when the voice command has been called, as an input. The execution condition determiner 122 then determines whether the execution condition for the voice command requested to be executed matches the current peripheral information. In the examples illustrated in FIGS. 6A and 6B, the determination method calculates the matching value with respect to table data of execution conditions. The determining method uses, for each row of data, peripheral information as an input. As illustrated in FIGS. 6A and 6B, when the smallest matching value among the matching values calculated for the respective rows is smaller than the threshold (a threshold y, for example) set for the respective execution conditions for voice commands, the execution condition determiner 122 determines the voice command to be “valid”. When the smallest matching value is equal to or larger than the threshold, the execution condition determiner 122 determines the voice command to be “invalid”.

As illustrated in FIGS. 6A and 6B, an example of the matching value is a weighted sum obtained by calculating a quantity that is given by a Levenshtein distance in a case where the peripheral information is a character string and is given by an absolute value of a difference in a case where the peripheral information is a numerical value for each piece of the peripheral information, and multiplying the calculated quantity by a weighting coefficient set for each piece of the peripheral information. Here, the Levenshtein distance corresponds to the minimum number of procedures necessary in transforming one character string into another character string by inserting, deleting, or replacing one character. For example, in the table of execution conditions shown in FIG. 6B, the matching value in the first row is 3. More specifically, the Levenshtein distance of the title column is 1, the Levenshtein distance of the process column is zero, the Levenshtein distance of the various value (URL) column is 3, the Levenshtein distance of the various value (heading) column is zero, the various value (contract price) column is a fixed value ß being none, and a matching value of 3 is obtained as a weighted sum that is the sum of these values of the corresponding columns multiplied by a. Likewise, a matching value of 4 is obtained as the matching value in the second row. Among these values, the smallest one is the matching value of 3, and the matching value of 3 is smaller than the threshold 4 set in the execution condition. Therefore, this execution condition is determined to be “valid”.

Here, the advantage of setting the weight a on each piece of peripheral information is that, in a case where a voice command should not be executed unless the various value (contract price) columns strictly match, for example, the corresponding weight a can be set as a large value, and the matching value can be made larger when the corresponding surrounding situation does not match, to enable strict determination. In this manner, the weight a can be used for fine control of determination of an execution condition.

Further, in the calculation of a matching value, a weight (the index i in FIG. 6B) in each row of the execution condition table is introduced in addition to the weight (the index j in FIG. 6A) in each column of the peripheral information table. With this arrangement, a matching value can be calculated so that the matching value of the execution condition learned most recently is small, and the matching value of an execution condition learned far back in the past is large.

### [4-2-3. Voice Command Display 123]

The voice command display 123 displays a user interface that enables the user to select a voice command by a method other than speech. The voice command display 123 is an example of the display.

Regarding a display timing, the voice command display 123 may display the user interface together with the voice command input screen. Alternatively, in a case where the execution condition determiner 122 determines that the peripheral information obtained by the peripheral information obtainer 121 does not match at least one condition of one or more conditions, the voice command display 123 may display the user interface.

The displayed user interface (a GUI, for example) receives an input (a GUI operation, for example) that is not speech. For example, the voice command display 123 presents a list of voice commands to the user, with the validity/invalidity of each voice command being clearly indicated. The list of voice commands allows the user to execute a voice commands shown in this list by a method other than speech. In a case where a voice command is invalid, the voice command cannot be executed by speech. This voice command can be executed by a method other than speech, through a voice command list display.

The voice command display 123 presents the list of voice commands to the user, with the validity/invalidity of each voice command being clearly shown in the current surrounding situation. The user can perform an operation on the list of voice commands presented by the voice command display 123. For example, the user may select a voice command by a method such as clicking, tapping, or the like, and activate the corresponding voice command.

A voice command in an invalid state cannot be executed by speech. However, a voice command in an invalid state can be executed by a method other than speech, through the voice command display 123.

The execution condition learning system 100 has a function of executing a voice command by a method other than speech, through the voice command display 123. In a case where the user wishes to execute the corresponding voice command in a situation where the execution condition does not match the surrounding situation, the execution condition is learned not through correction of the execution condition but through activation of the corresponding voice command from the voice command display 123 by a method other than speech. This eliminates the need for the user to correct the execution condition.

Further, in a case where a specific voice command is repeatedly executed by operating the voice command display 123 (by a method other than speech), the execution condition learning system 100 can determine that the learning of the execution condition for the corresponding voice command is not successful. In such a case, the execution condition learning system 100 (the voice command display 123, for example) alleviates the execution condition by dynamically increasing the threshold for the execution condition for the corresponding voice command, to enable automatic adjustment of the execution condition so that the corresponding voice command can be executed by speech.

### [4-2-4. Voice Command Executor 124]

The voice command executor 124 executes a voice command. The voice command executor 124 is an example of the executor.

In a case where the execution condition determiner 122 determines that the peripheral information obtained by the peripheral information obtainer 121 matches at least one condition of one or more execution conditions, the voice command executor 124 executes the voice command. In a case where the voice command display 123 accepts selection of a voice command via the user interface, the voice command executor 124 also executes the voice command.

The voice command executor 124 receives speech data from the voice input device 140. To execute a voice command in accordance with speech data, the voice command executor 124 can implement a voice recognition system.

### [4-2-5. Execution Condition Learner 125]

The execution condition learner 125 learns the peripheral information obtained by the peripheral information obtainer 121 as a condition for executing a voice command. The execution condition learner 125 is an example of the executor.

For example, in a case where the voice command executor 124 has executed a voice command, the execution condition learner 125 learns the peripheral information as a condition for executing the voice command.

The condition for executing the voice command is an execution condition for the voice command. The execution condition learner 125 stores the execution condition into the storage module 130 as learning of the execution condition.

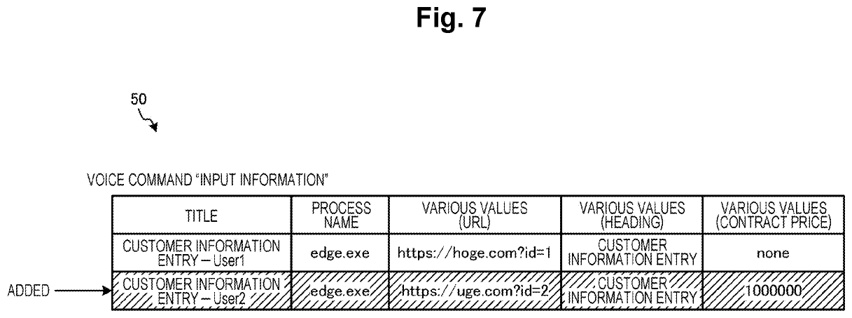

FIG. 7 illustrates an execution condition learning process 50 that is an example of an execution condition learning process according to the present disclosure. In the execution condition learning process 50, the execution condition learner 125 newly learns the peripheral information at the time of execution of a voice command, as an execution condition for the voice command. When a voice command is executed, the execution condition learner 125 learns the peripheral information obtained at that time as an execution condition. As illustrated in FIG. 7, execution conditions are table data including a plurality of pieces of peripheral information. The obtained peripheral information is added as new row data. The table data of execution conditions is present for each voice command. The execution condition is added to the table data of the executed voice command.

### [4-3. Storage Module 130]

The storage module 130 is implemented by a semiconductor memory element such as a RAM or a flash memory, or a storage device such as a hard disk or an optical disk, for example. The storage module 130 stores the peripheral information obtained by the peripheral information obtainer 121, and the plurality of execution conditions learned by the execution condition learner 125.

### [4-4. Voice Input Device 140]

The voice input device 140 receives speech of the user. The voice input device 140 then supplies the data of the speech (which is voice data) to the voice command executor 124.

### 5. FLOWCHART OF AN EXECUTION CONDITION LEARNING PROCESS

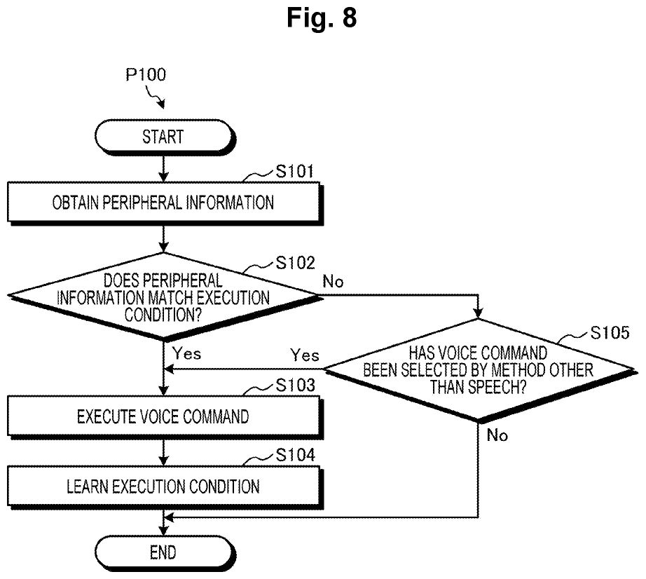

Next, a flowchart of an example of an execution condition learning process according to the present disclosure is described with reference to FIG. 8. Examples of execution condition learning processes include a process for learning an execution condition for a voice command. The process for learning an execution condition for a voice command is performed by the execution condition learning system 100 illustrated in FIG. 4, for example.

FIG. 8 is a flowchart showing a process P100 that is an example of the process for learning an execution condition for a voice command.

As illustrated in FIG. 8, the peripheral information obtainer 121 of the execution condition learning system 100 first obtains the peripheral information about the user who is the speaker (step S101).

The execution condition determiner 122 of the execution condition learning system 100 then determines whether the peripheral information matches the execution condition (step S102).

If the execution condition determiner 122 determines that the peripheral information matches the execution condition (step S102: Yes), the voice command executor 124 of the execution condition learning system 100 executes the voice command (step S103).

The execution condition learner 125 of the execution condition learning system 100 then learns the peripheral information as an execution condition (step S104). Note that the execution condition learner 125 may check with the user whether to learn the peripheral information as an execution condition. For example, the execution condition learner 125 may display a GUI including a message such as “Is the peripheral information to be learned as an execution condition?”. In a case where the user selects a “learn” button, the execution condition learner 125 may learn the peripheral information as an execution condition.

If the execution condition determiner 122 determines that the peripheral information does not match the execution condition (step S102: No), the voice command display 123 of the execution condition learning system 100 determines whether the voice command has been selected by a method other than speech (step S105). The voice command display 123 can display a user interface that enables selection of a voice command by a method other than speech. The voice command display 123 can receive selection of a voice command via the user interface.

If the voice command display 123 determines that the voice command has been selected by a method other than speech (step S105: Yes), the processing step moves on to step S103.

If the voice command display 123 determines that the voice command has not been selected by a method other than speech (step S105: No), the processing step comes to an end.

### 6. EFFECTS

As described above, the execution condition learning system 100 learns an execution condition for a voice command, from the surrounding situation at the time of execution of the voice command. The execution condition learning system 100 further has a function for executing a voice command by a method other than speech. Accordingly, the execution condition learning system 100 can interactively learn execution conditions that match various surrounding situations. This eliminates the need to define execution conditions in advance.

As a result, the execution condition learning system 100 can significantly reduce the operation related to definition and correction of an execution condition for a voice command. Furthermore, even a user with low skills (with poor understanding of information indicating a situation, for example) can easily set an execution condition for a voice command.

### 7. OTHER ASPECTS

Some of the processes described as processes to be automatically performed may be performed manually. Alternatively, all or some of the processes described as processes to be performed manually can be automatically performed by a known method. Further, the procedures of processes, the specific names, and the information including various kinds of data and parameters described and illustrated in this specification and the drawings can be changed as appropriate, unless otherwise specified. For example, various kinds of information shown in the drawings are not limited to those shown in the drawings.

The components of the system and the devices illustrated in the drawings are conceptual illustrations of the functions of the system and the devices. The components are not necessarily physically designed as illustrated in the drawings. In other words, specific forms of the distributed or integrated system and devices are not limited to the forms of the system and the devices illustrated in the drawings. All or some of the system and the devices may be functionally or physically distributed or integrated, depending on various loads and usage situations.

### 8. HARDWARE CONFIGURATION

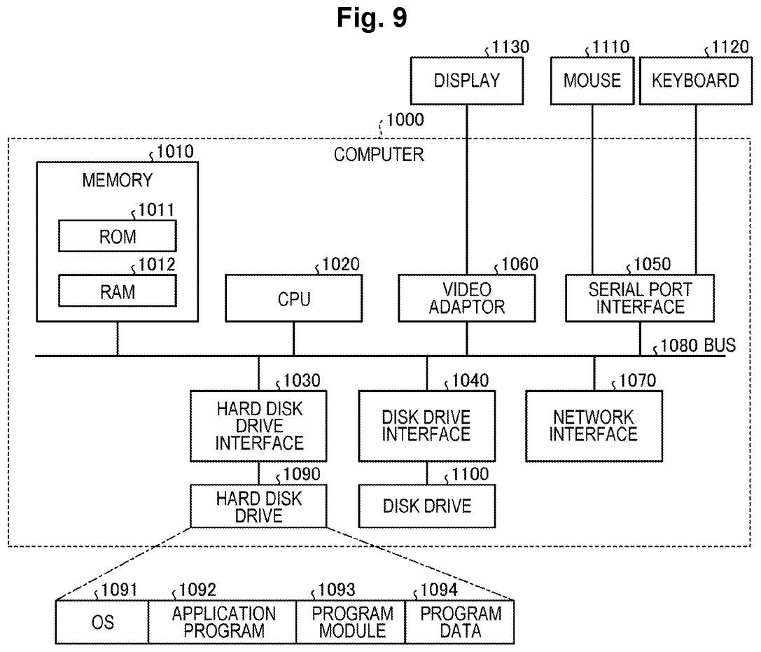

FIG. 9 is a diagram illustrating a computer 1000 that is an example hardware configuration of a computer. The system and methods described in this specification are implemented by the computer 1000 illustrated in FIG. 9, for example.

FIG. 9 illustrates an example of a computer that implements the execution condition learning system 100 by executing a program. The computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These components are connected by a bus 1080.

The memory 1010 includes a read only memory (ROM) 1011 and a RAM 1012. The ROM 1011 stores a boot program such as a basic input output system (BIOS), for example. The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to a display 1130, for example.

The hard disk drive 1090 stores an OS 1091, an application program 1092, a program module 1093, and program data 1094, for example. That is, the program that specifies each process to be performed by the execution condition learning system 100 is implemented as the program module 1093 in which codes executable by the computer 1000 are written. The program module 1093 is stored in the hard disk drive 1090, for example. The program module 1093 for performing processes as in the functional configuration in the execution condition learning system 100 is stored in the hard disk drive 1090, for example. Note that the hard disk drive 1090 may be replaced with a solid state drive (SSD).

The hard disk drive 1090 can store a learning program for an execution condition learning process. Also, the learning program can be created as a program product. When executed, the program product implements one or more methods as described above.

Furthermore, the setting data that is used in the processes of the embodiment described above is stored as the program data 1094 in the memory 1010 or the hard disk drive 1090, for example. The CPU 1020 then reads the program module 1093 and the program data 1094 stored in the memory 1010 and the hard disk drive 1090 into the RAM 1012 as necessary, and executes the program module 1093 and the program data 1094.

Note that the program module 1093 and the program data 1094 are not necessarily stored in the hard disk drive 1090, but may be stored in a removable storage medium and be read by the CPU 1020 via the disk drive 1100 or the like, for example. Alternatively, the program module 1093 and the program data 1094 may be stored in another computer connected via a network (a LAN, a WAN, or the like). The program module 1093 and the program data 1094 may be then read by the CPU 1020 from another computer via the network interface 1070.

### 9. SUMMARY OF THE EMBODIMENT

As described above, the execution condition learning system 100 according to the present disclosure includes the peripheral information obtainer 121 and the execution condition learner 125. In at least one embodiment, the peripheral information obtainer 121 obtains information observed around the user who has uttered a voice command. The execution condition learner 125 learns the information obtained by the peripheral information obtainer 121 as a condition for executing the voice command.

As described above, the execution condition learning system 100 according to the present disclosure includes the execution condition determiner 122 and the voice command executor 124. In some embodiments, the execution condition determiner 122 identifies one or more conditions for executing the voice command, and determines whether the information obtained by the peripheral information obtainer 121 matches at least one condition of the one or more conditions. In some embodiments, in a case where the execution condition determiner 122 determines that the information obtained by the peripheral information obtainer 121 matches at least one condition of the one or more conditions, the voice command executor 124 executes the voice command. In some embodiments, in a case where voice command executor 124 has executed the voice command, the execution condition learner 125 learns the information obtained by the peripheral information obtainer 121 as a condition for executing the voice command.

As described above, the execution condition learning system 100 according to the present disclosure includes the voice command display 123. In some embodiments, the voice command display 123 displays a user interface that enables the user to select a voice command by a method other than speech. In some embodiments, in a case where the voice command display 123 accepts selection of a voice command via the user interface, the voice command executor 124 executes the voice command.

In some embodiments, to determine whether the information obtained by the peripheral information obtainer 121 matches at least one condition of the one or more conditions, the execution condition determiner 122 sets a value indicating how much the information obtained by the peripheral information obtainer 121 differs from at least one condition of the one or more conditions, and determines whether the set value is smaller than a threshold.

In some embodiments, the peripheral information obtainer 121 obtains information regarding a voice command input screen that can accept a voice command from the user, as information observed around the user who has uttered the voice command.

In some embodiments, the peripheral information obtainer 121 obtains, as the information regarding the voice command input screen, information including at least one of the title of the voice command input screen, the process name of the voice command input screen, or a value displayed on the voice command input screen.

Although various embodiments have been described in detail in this specification with reference to the drawings, these embodiments are merely examples and are not intended to limit the present invention to these embodiments. The features described in this specification may be achieved by various methods, including various modifications and improvements based on the knowledge of those skilled in the art.

Further, each “module”, each suffix “-er”, and each suffix “-or” in the above description can be read as a unit, a means, a circuit, or the like. For example, a communication module, a control module, and a storage module can be read as a communication unit, a control unit, and a storage unit, respectively. Also, each control module (the peripheral information obtainer, for example) in the control module 120 can be read as a peripheral information obtaining unit.

### REFERENCE SIGNS LIST

1 Environment
100 Execution condition learning system
110 Communication module
120 Control module
121 Peripheral information obtainer
122 Execution condition determiner
123 Voice command display
124 Voice command executor
125 Execution condition learner
130 Storage module
140 Voice input device
200 Network
300 Voice control target

1. A learning system comprising a processor configured to execute operations comprising:
obtaining information observed around a user who has uttered a voice command; and
learning the obtained information as a condition for executing the voice command.

2. The learning system according to claim 1, the processor further configured to execute operations comprising:
identifying one or a plurality of conditions for executing the voice command;
determining whether the obtained information matches at least one condition of the one or the plurality of conditions; and
executing the voice command, when the determining further comprises determining that the obtained information matches at least one condition of the one or the plurality of conditions, wherein,
when the executing further comprises executing the voice command, the learning further comprises learning the obtained information as a condition for executing the voice command.

3. The learning system according to claim 2, the processor further configured to execute operations comprising
displaying a user interface that enables the user to select the voice command by a method other than speech, wherein,
when the displaying further configured to receiving selection of the voice command via the user interface, the executing further comprises executing the voice command.

4. The learning system according to claim 2, wherein the determining further comprises:
setting a value indicating how much the obtained information differs from at least one condition of the one or the plurality of conditions, and
determining whether the set value is smaller than a threshold to determine whether the obtained information matches at least one condition of the one or the plurality of conditions.

5. The learning system according to claim 1, wherein
the obtaining further comprises obtaining information regarding a voice command input screen that accepts the voice command from the user, as the information observed around the user who has uttered the voice command.

6. The learning system according to claim 5, wherein
the obtaining further comprises obtaining, as the information regarding the voice command input screen, the information including at least one of:
a title of the voice command input screen,
a process name of the voice command input screen, or
a value displayed on the voice command input screen.

7. A method for learning, comprising:
obtaining information observed around a user who has uttered a voice command; and
learning the information obtained in the obtaining step as a condition for executing the voice command.

8. A computer-readable non-transitory recording medium storing a computer-executable program instructions that when executed by a processor cause a computer system to execute operations comprising:
obtaining information observed around a user who has uttered a voice command; and
learning the obtained information as a condition for executing the voice command.

9. The learning system according to claim 2, wherein the obtaining further comprises obtaining information regarding a voice command input screen that accepts the voice command from the user, as the information observed around the user who has uttered the voice command.

10. The method according to claim 7, further comprising:
identifying one or a plurality of conditions for executing the voice command;
determining whether the obtained information matches at least one condition of the one or the plurality of conditions; and
executing the voice command, when the determining further comprises determining that the obtained information matches at least one condition of the one or the plurality of conditions, wherein,
when the executing further comprises executing the voice command, the learning further comprises learning the obtained information as a condition for executing the voice command.

11. The method according to claim 10, further comprising:
displaying a user interface that enables the user to select the voice command by a method other than speech, wherein,
when the displaying further configured to receiving selection of the voice command via the user interface, the executing further comprises executing the voice command.

12. The method according to claim 10, wherein,
the determining further comprises:
setting a value indicating how much the obtained information differs from at least one condition of the one or the plurality of conditions, and
determining whether the set value is smaller than a threshold to determine whether the obtained information matches at least one condition of the one or the plurality of conditions.

13. The method according to claim 7, wherein
the obtaining further comprises obtaining information regarding a voice command input screen that accepts the voice command from the user, as the information observed around the user who has uttered the voice command.

14. The method according to claim 10, wherein
the obtaining further comprises obtaining information regarding a voice command input screen that accepts the voice command from the user, as the information observed around the user who has uttered the voice command.

15. The method according to claim 13, wherein
the obtaining further comprises obtaining, as the information regarding the voice command input screen, information including at least one of:
a title of the voice command input screen,
a process name of the voice command input screen, or
a value displayed on the voice command input screen.

16. The computer-readable non-transitory recording medium according to claim 8, the computer-executable program instructions when executed further causing the computer system to execute operations comprising:
identifying one or a plurality of conditions for executing the voice command;
determining whether the obtained information matches at least one condition of the one or the plurality of conditions; and
executing the voice command, when the determining further comprises determining that the obtained information matches at least one condition of the one or the plurality of conditions, wherein,
when the executing further comprises executing the voice command, the learning further comprises learning the obtained information as a condition for executing the voice command.

17. The computer-readable non-transitory recording medium according to claim 16, the computer-executable program instructions when executed further causing the computer system to execute operations comprising:
displaying a user interface that enables the user to select the voice command by a method other than speech, wherein,
when the displaying further configured to receiving selection of the voice command via the user interface, the executing further comprises executing the voice command.

18. The computer-readable non-transitory recording medium according to claim 16, wherein,
the determining further comprises:
setting a value indicating how much the obtained information differs from at least one condition of the one or the plurality of conditions, and
determining whether the set value is smaller than a threshold to determine whether the obtained information matches at least one condition of the one or the plurality of conditions.

19. The computer-readable non-transitory recording medium according to claim 8, wherein
the obtaining further comprises obtaining information regarding a voice command input screen that accepts the voice command from the user, as the information observed around the user who has uttered the voice command.

20. The computer-readable non-transitory recording medium according to claim 19, wherein
the obtaining further comprises obtaining, as the information regarding the voice command input screen, information including at least one of:
a title of the voice command input screen,
a process name of the voice command input screen, or
a value displayed on the voice command input screen.
